(19) United States
(12) Patent Application Publication
(10) Pub. No.: US 2005/0114519 A1
(43) Pub. Date: May 26, 2005

(54) Procedure to view updated contents in digital supports, via internet

(76) Inventor: Pedro Gallego Rubio, Olivares (Sevilla) (ES)

Correspondence Address: WILLIAM COLLARD;COLLARD & ROE, P.C., 1077 NORTHERN BOULEVARD, ROSLYN, NY, 11576, US

(21) Appl. No.: 11/023,846

(22) Filed: Dec. 28, 2004

Related U.S. Application Data
(63) Continuation of application No. PCT/ES03/00310, filed on Jun. 23, 2003.

(30) Foreign Application Priority Data
Jun. 28, 2002 (ES) P200201507

(51) Int. Cl. G06F 15/16

(52) U.S. Cl. 709/227

(57) ABSTRACT

Procedure to view updated contents in digital supports, via Internet. The present invention is focused on the use of a digital support as for example the type: cd-rom, mini cd-rom, cd-card, dvd-rom, or dvd-card where we have recorded an information beforehand (images, sounds, effects, etc.) that serves us as a guide, remaining some areas that will be modified and updated via the Internet just at the moment we insert the digital support in the corresponding reader, and this is connected to the Internet; being updated this way part or all the information that we view as it is linked to the Internet.

This invention is framed in the technical sector of the updating process of information housed in digital supports as for example the types: cd-rom, cd-card, mini cd-rom, dvd-rom or dvd-card, by replacement, via Internet.

At the present time several forms are used to access the information in the Internet. These systems consist of the access to the information in the Internet through a connection with an URL, with the employment of a navigator, and by means of a magneto optic disk, or devices, in any case, recordable.

In the same way, the well-known systems until the present time use ROM memory types (small wires printed in a chip), PROM (matrix of wired transistors that can be programmed to burn electrically and selectively the individual transistors) and EPROM (programmable and re-wearable).

In all the mentioned systems, also, it is required the previous installation of a download program or software to carry out the update of the information.

However, the present invention is centered in the use of digital supports, where we have recorded beforehand some images, sounds, effects etc. that serve us as a guide, remaining some areas that will be implemented via Internet just at the time we insert these supports in the corresponding reader and this is connected to the Internet net; being updated this way the information that we view as it is linked to the Net, without the need of manipulating or replacing these digital supports, and without the need of installating a program, decreasing, therefore, the access speed or download of a specific information or, even making the download instantaneous, without the need to wait on the part of the user.

That's why the following invention contributes, with respect to the state of the technology, with a procedure for the updated visualization of information housed in a digital support that doesn't require of the installation of any program, application or any other system that it is not the operating system itself.

The “procedure to view updated contents in digital supports, via Internet” is composed of a digital support, which contains a guide of visualization of the contents adapted to the necessities of the product, service or information that it is meant to present, consisting in a structure of active areas of localizations and concrete dimensions linked to an address in the Internet where, once carried out the connection, they are linked in an instantaneous way to the updated files of the Net server, of the references object of visualization. This way, the application of the procedure associated to the visualization guide of the digital support employed is implemented by means of an application already carried out by the existent programs in the market for the administration and the treatment of images, sound, etc. and it allows the user to manage the virtual support as he/she pleases and to increase the information of the products that he/she has bigger interest.

This way, the “procedure to view updated contents in digital supports, via Internet” consists of introducing in the corresponding reader (according to the type of the selected digital support) of an user with access to the Net, the digital support in which a specific guide of visualization of products is housed so that, in an automatic way, the files are implemented on the guides by means of an IP communication manager, upgrading the different references object of visualization that reside in an Internet server and the displacement in the virtual image begins.

The procedure object of the present invention, therefore, doesn't require room for memory to store the information, but rather this is viewed time by the user in real.

By way of example of preferent realization of the “procedure to view updated contents in digital supports, via Internet” a multimedia design with its corresponding procedure application is inserted in the selected type of digital support, from where it is visualized, for example, the content of an art gallery, according to the following stages:
1. Taking of pictures and necessary videos to have the enough images according to the necessities of the promoter of the art gallery.
2. Designing of a guide of the art gallery, to be inserted in the digital support, in three floors, where each floor has its own distribution in specific rooms and the visit is carried out in a 360° display on each room by means of a previous selection of the floor and room. The guide once carried out, consists of physical spaces free of location and with concrete dimensions where the pictures that reside in the Internet server will be inserted and implemented and that allows the user, once the selected digital support is inserted in the corresponding reader and visualize the virtual image of the gallery, to select a picture with the mouse, enlarging it in an instantaneous way and providing information on the dimensions, price, author, title and date of creation of each work of art.
3. Assembling of images, sound, effects by means of programs such as: FreeHand, Photoshop, Flash, Dreamweaver, Swift-3D and Cute Ftp, etc.
4. Uploading of picture files to the Internet server.
5. Insertion of a guide of the art gallery in a digital support selected according to its adaptation to the project that it is going to be carried out, that includes immediate activation as it is inserted in an appropriate reader, activation of the implementation of pictures updated by means of the connection to the Internet server via IP and visualization of contents.

This way, once the designs have been introduced in the digital support, the procedure application, that will make the information is implemented through the Internet, is introduced. These supports will be distributed to their users so that they can make use of them in any computer with connection to the Internet.

Once it is inserted in the corresponding reader, the user, at any momment he/she uses this digital support, will be able to have access to the virtual image of the art gallery with the image of the updated pictures; those sold having disappeared and appearing the new ones available by replacement, via server, of the virtual image of the picture that has been called or connected to the location or previously assigned physical space of the created guide.

Everything with the guarantee, therefore, that the available and visualized pictures represent the real ones at any time, while the promoter of the art gallery uploads the contents in the Internet server.

This example of preferent realization consists of one of the many applications of the present invention, which can be applied to any kind of product in the market without distinction, be or not linked to a physical space like, even, books or publications with upgrading of the content.

It is not considered necessary to make more extensive this description so that any expert on the matter understands the reach of the invention and the advantages that are derived of the same one. The materials, form, size and disposition of the elements used in the realization of this invention as well as the technology that gives support to the present procedure will be susceptible of variation provided it doesn't change the essentials of this invention.

1. The procedure to view updated contents in digital supports, via Internet, is characterized by digital supports as for example the type: cd-rom, cd-card, mini cd-rom, dvd-rom, or dvd-card in which are introduced, by means of the necessary programming, multimedia contents that are recorded in the same ones, by way of a guide, and where coexist fixed areas (non upgradable) and active areas or connection points (upgradable), and in whose fixed area is inserted the necessary programming, consistent in an automatic call (auto-executable) to an url, and that will replace the contents of those active areas that have been modified in the Internet server or Hosting via IP, so that when the digital support is inserted in the reader of a computer connected to the Internet, implement and show the updated information.

2. The procedure to view updated contents in digital supports, via Internet according to claim 1, is characterized because the support is completely autonomous, lacking the necessity of installation of any program, to be able to view the updated information, the guide being already programmed by means of system of upgrade of contents via FTP to contain a structure of active areas of localizations, linked to an Internet address, without the need of a navigator and from where, once carried out the connection, they are uploaded via FTP in an automatic and instantaneous way and the files of the references object of visualization in adapted formats.

3. The procedure to view updated contents in digital supports, via Internet according to claim 1, is characterized because the implementation when introducing the digital support in the computer of an user with access to Internet, loads the updated files of the different references object of visualization that reside in an Internet server, on the guide by means of an FTP communication manager, not needing in any case to store the loaded information of the Internet, but rather it is shown in the same moment in which is implemented.
